(19) United States
(12) Patent Application Publication
(10) Pub. No.: US 2010/0174913 A1
(43) Pub. Date: Jul. 8, 2010

(54) MULTI-FACTOR AUTHENTICATION SYSTEM FOR ENCRYPTION KEY STORAGE AND METHOD OF OPERATION THEREFOR

(76) Inventors: Simon B. Johnson, Bonney Lake, WA (US); Lev M. Bolotin, Kirkland, WA (US)

Correspondence Address: LAW OFFICES OF MIKIO ISHIMARU, 333 W. EL CAMINO REAL, SUITE 330, SUNNYVALE, CA, 94087, US

(21) Appl. No.: 12/652,035

(22) Filed: Jan. 4, 2010

Related U.S. Application Data
(60) Provisional application No. 61/142,349, filed on Jan. 3, 2009.
(60) Provisional application No. 61/143,155, filed on Jan. 7, 2009.

(51) Int. Cl. G06F 21/00; H04L 9/08

(52) U.S. Cl. 713/186; 380/278; 713/185

(57) ABSTRACT

A method for operating a multi-factor authentication system includes: authenticating a user by a self-authenticating token system; and retrieving a decryption key from the self-authenticating token system by a computer system after authenticating the user, the computer system using encryption to encrypt data.

### CROSS REFERENCE TO RELATED APPLICATION(S)

This application claims the benefit of U.S. Provisional Patent Application Ser. No. 61/142,349 filed Jan. 3, 2009, and the subject matter thereof is incorporated herein by reference thereto.

This application also claims the benefit of U.S. Provisional Patent Application Ser. No. 61/143,155 filed Jan. 7, 2009, and the subject matter thereof is incorporated herein by reference thereto.

The present application contains subject matter related to co-pending U.S. patent application Ser. No. 11/996,501. The related application is assigned to ClevX, LLC and the subject matter thereof is incorporated herein by reference thereto.

### TECHNICAL FIELD

The present invention relates generally to computer systems, and more specifically to encrypted memory within the computer system.

### BACKGROUND ART

Security is a critical issue with almost all aspects of computer use and mobile electronic device use, including portable memory storage devices. This also applies to any electronic products, such as camcorders, digital cameras, iPODs, MP3 players, smart phones, palm computers, gaming devices, etc., using such devices.

Whether it is logging into an email account, protecting personal medical information, family pictures, etc. or accessing bank information, information must be supplied to gain access to view personal data. A great deal of money and effort has been applied to guarding personal, corporate, and government information from hackers and others.

Current computer systems provide data protection against unauthorized access. For example, Bitlocker™ is a data protection feature available with Windows® operating systems that encrypts vital information stored on the computer's primary disk partition. Other examples of encryption used to protect a computer's sensitive data include Apple's FileVault, TrueCrypt, and dm-crypt.

Bitlocker locks the normal boot process until the user supplies a PIN (Personal Identification Number), or connects a USB (Universal Serial Bus) flash drive containing the correct decryption-encryption key. In the latter case, a flash drive must be connected to the USB port of the computer before the computer will boot. If the appropriate decryption-encryption key is not supplied, the computer will not boot and data stored on the computer memory is undecipherable.

While a decryption-encryption key stored on a USB drive is a deterrent from unauthorized access, it is not completely secure. Most users keep their external Bitlocker drive with the computer that it unlocks. Therefore, this makes it easy to steal, because the USB drive is most likely stored in the computer's travel bag or left in the computer's USB port.

A goal, for this type of data protection, is “multi-factor authentication” in which the computer requires “something you have” (flash drive) and “something you know” (password or PIN). Unfortunately, multi-factor authentication fails as it is reduced to simply something you have; i.e., the USB drive containing the decryption-encryption key.

There are a number of secure USB storage devices on the market, but many require the computer's operating system to be fully functional in order facilitate the security features of the storage device. A secure storage device would be the ideal solution to the problem above except it needs a fully functional computer operating system. Since the operating system requires access to a decryption-encryption key, secure storage devices remain locked and cannot be accessed. The best solution to this problem is to use a secure storage device that is capable of authenticating the user without the need for computer resources.

Solutions to these problems have been long sought but prior developments have not taught or suggested any solutions and, thus, solutions to these problems have long eluded those skilled in the art.

### DISCLOSURE OF THE INVENTION

The present invention provides a method for operating a multi-factor authentication system that includes: authenticating a user by a self-authenticating token system and retrieving a decryption key from the self-authenticating token system by a computer system after authenticating the user, the computer system using encryption to encrypt data.

The present invention provides a multi-factor authentication system that includes: a self-authenticating token system having: an input mechanism for authenticating a user and a storage module connected to the input mechanism for containing a decryption key for retrieval by a computer system after the user is authenticated.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a block diagram showing a multi-factor authentication system in accordance with an embodiment of the present invention.

FIG. 2 is a block diagram showing a self-authentication token system in accordance with another embodiment of the present invention.

FIG. 3 is a process flow for validating the user and supplying a decryption-encryption key to the computer system in accordance with embodiments of the present invention.

FIG. 4 is a block diagram showing a self-authenticating token system with multiple keys in accordance with a further embodiment of the present invention.

FIG. 5. is a flow chart of a method for operating the multi-factor authentication system of FIG. 1.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the apparatus/device are semi-diagrammatic and not to scale and, particularly, some of the dimensions are for clarity of presentation and are shown greatly exaggerated in the drawing FIGs.

Similarly, the drawings generally show similar orientations of embodiments for ease of description, but this is arbitrary for the most part. Generally, the various embodiments can be operated in any orientation.

Embodiments of the present invention relate to computer systems with memory systems as exemplified by personal computers having mass storage drives.

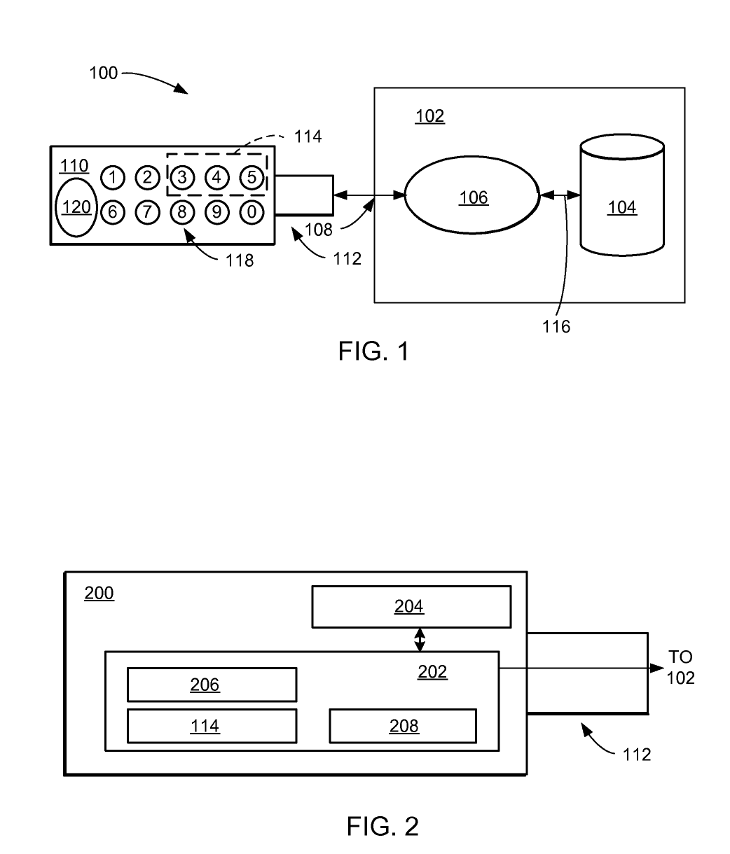

Referring now to FIG. 1, therein is shown a block diagram showing a multi-factor authentication system 100 in accordance with an embodiment of the present invention.

The multi-factor authentication system 100 is composed of a computer system 102 having a mass storage drive 104. The mass storage drive 104 may be an electronic memory or hard disk and have one or more encrypted partitions. The encrypted data in the mass storage drive 104 is accessed through a decryption-encryption algorithm unit 106. The decryption-encryption algorithm unit 106 is connected to an input connector such as a standard USB (Universal Serial Bus) port 108.

The multi-factor authentication system 100 includes a self-authenticating token system 110. The self-authenticating token system 110 can be a physical device, flash drive, mobile phone, or other portable or mobile device, which is connectible to the computer system 102. The connection can be a standard type of connection such as a USB connector 112 for the USB port 108.

The self-authenticating token system 110 can contain a decryption key for only deciphering data but more often the self-authenticating token system 110 contains a decryption-encryption key 114 for deciphering and encrypting data 116 from and to the encrypted partition of the mass storage drive 104 and providing “clear” or unencrypted data to the USB port 108. The decryption-encryption algorithm unit 106 in the computer system 102 reads the decryption-encryption key 114 from the self-authenticating token system 110 and uses it to decipher-encrypt the data 116.

The self-authenticating token system 110 will remain locked and the decryption-encryption key inaccessible until a user has been authenticated by providing authenticating information, such as a PIN (Personal Identification Number), by means of an input mechanism, such as numerical buttons 118 or fingerprint identifier 120.

In other words, the user must interact with the self-authenticating token system 110 to validate authorization and allow the decryption-encryption key 114 to be retrieved by the decryption-encryption algorithm unit 106 of the computer system 102.

Thus, the user of the computer system 102 uses multi-factor authentication to access data from the mass storage drive 104; i.e., more than one factor is required for authentication and access to data. For example in a two-factor system, it is necessary that a user “have something”, such as the self-authenticating token system 110, and “know something”, such as a PIN applied as a code input into the numerical buttons 118 of the self-authenticating token system 110.

Another embodiment of this invention requires that a user “have something”, such as the self-authenticating token system 110, and “be something”, such as being a user with authorized fingerprints applied to a fingerprint identifier 120 of the self-authenticating token system 110.

In these embodiments, the self-authenticating token system 110 authenticates the user “off-line” without using resources of the computer system 102.

In another embodiment, the self-authenticating token system 110 includes a memory, a micro-controller, a manipulatable input device, and a display like the memory lock device disclosed in U.S. Patent Application 2008/0215841, the disclosure of which is incorporated herein by reference thereto.

Referring now to FIG. 2, therein in is shown a block diagram showing a self-authenticating token system 200 in accordance with another embodiment of the present invention.

The self-authenticating token system 200 is composed of two modules: a block storage module 202 and a user input module 204. The block storage module 202 appears as a type of block storage device to the computer system 102. Typically, block storage devices attach as a standard mass storage drive and appear as a drive letter under Windows. Within the block storage module 202 is the decryption-encryption key 114, a timer 208, and an authentication parameter unit 206.

Once the user input module 204 has authenticated a user according to the authentication parameter unit 206, the computer system 102 is allowed to read the decryption-encryption key 114.

The timer 208 is used to prevent reading of the decryption-encryption key 114 after a predetermined time. For example, if the self-authenticating token system 200 were unlocked, the computer system 102 is allowed to access to the decryption-encryption key 114 for one minute. After one minute expires, the self-authenticating token system 200 locks and the decryption-encryption key 114 can no longer be read.

The user input module 204 supplies the interface between the user and the block storage module 202. The user input module 204 may consist of the numerical buttons 118 of FIG. 1 that when pushed in certain order, allow the decryption-encryption key 114 to be read by the computer system 102. In this embodiment, the numerical buttons 118 allows a user to enter a PIN, which can then be compared against a PIN in the authentication parameter unit 206.

The user input module 204 may be any number of human input mechanisms that can interact with the user. Examples of these mechanisms are:
Buttons—for entering a series of numbers like an ATM machine
Thumb-wheel—for entering a series of numbers or letters like a code lock
Fingerprint reader—for receiving and analyzing a user's fingerprint
RF module—for receiving an authentication signal from a radio frequency transmitting key fob.

The above list is not comprehensive and combinations of the above may be used in a single multi-factor self-authentication token system.

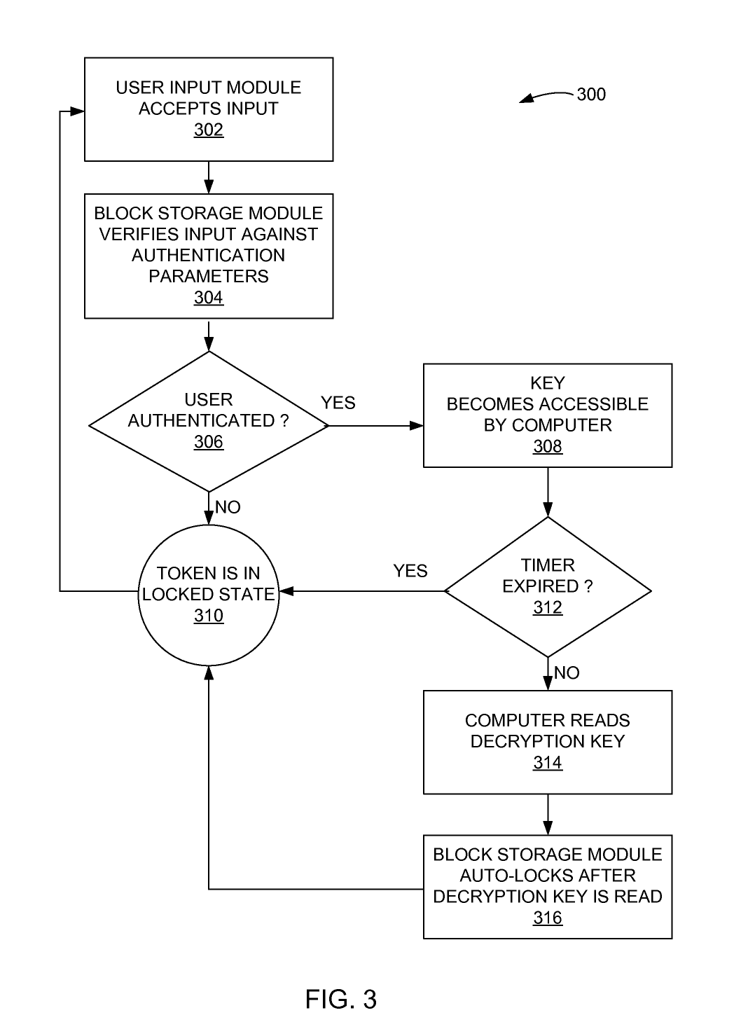

Referring now to FIG. 3, therein is shown a process flow 300 for validating the user and supplying a decryption-encryption key 114 of FIGS. 1 and 2 to the computer system 102 in accordance with embodiments of the present invention.

The process starts with reference to FIG. 2 when the user input module accepts an input from a user in a block 302. From the list above, this can be a code, PIN, fingerprint, etc. The block storage module then verifies data sent from the user input module and compares this with the authentication parameter unit in a block 304.

A check is then made to determine whether the data in the authentication parameter unit match those supplied by the user in a decision block 306. If yes, the decryption-encryption key becomes accessible by the computer system in a block 308. If no, the self-authenticating token system remains locked in a block 310 and the process returns to the user input module accepts input in the block 302.

When the user has been authenticated as the described above, the self-authenticating token becomes unlocked, and the decryption-encryption key has been made accessible to the computer system, the timer is used to measure a preset interval and check to determine if the timer has expired in a decision block 312. When the interval expires, the self-authenticating token system will lock in the block 310 and no longer be accessible by the computer system.

During the time the timer is not expired, the self-authenticating token system 200 remains unlocked, the computer system may read the decryption-encryption key in a block 314. After the decryption-encryption key 114 is read, the block storage module will automatically block access to the decryption-encryption key in a block 316 and the token system will be locked in the block 310. The block storage module 202 of FIG. 2 is able to provide the key as a normal function of block storage modules and it is within the level of those having ordinary skill in the art to add the relocking function to a block storage module firmware.

Thus, the decryption-encryption key 114 automatically becomes inaccessible after a limited period of time or immediately after it is used. The self-authenticating token system 200 must authenticate the user again for the decryption-encryption key 114 to be used after the timer has expired or to be used again after one use.

The process flow 300 above prevents malware in the computer system 102 from accessing the decryption-encryption key 114 after it has been used once.

In brief summary, the multi-factor authentication system 100 of FIG. 1 includes: providing the computer system 102 equipped with the mass storage drive 104 having encrypted data; the self-authenticating token system 110 or 200 of FIGS. 1 and 2 containing the decryption-encryption key 114; and the computer system 102 having the decryption-encryption algorithm unit 106 for accepting the decryption-encryption key 114 from the self-authenticating token system 200 and using it to decrypt/encrypt data from and to the mass storage drive 104.

The multi-factor authentication system 100 may further include a mass storage drive that may have multiple encrypted and unencrypted partitions.

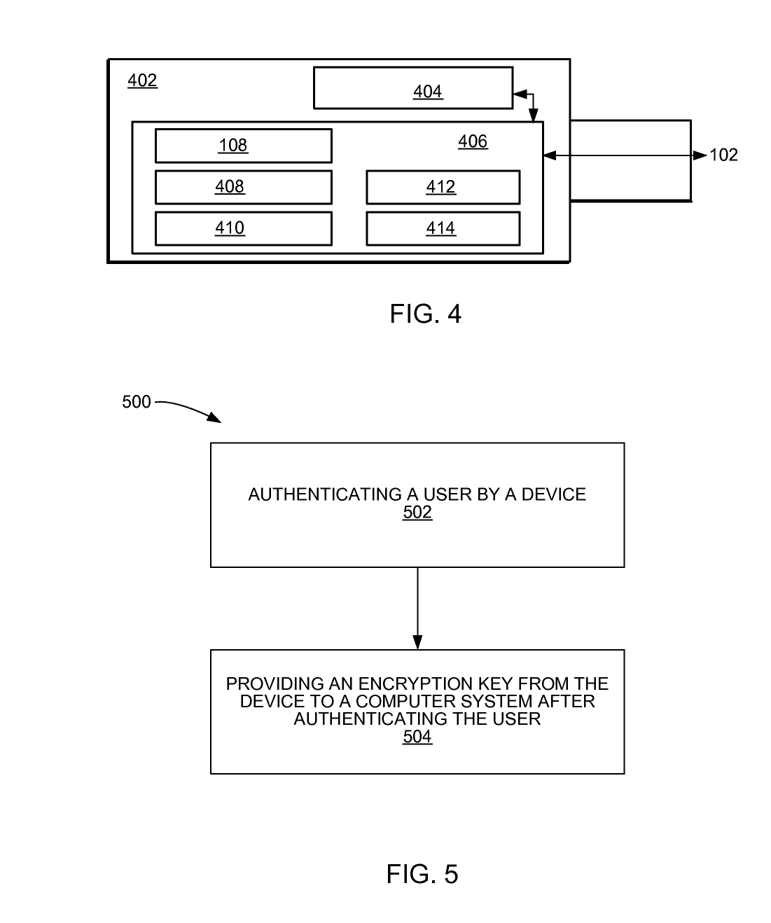

Referring now to FIG. 4, therein is shown a block diagram showing a self-authenticating token system 402 with multiple keys in accordance with a further embodiment of the present invention.

A user may enter PIN A into a user input module 404 to unlock the self-authenticating token system 402. The PIN A in a block storage module 406 is associated with authentication parameter unit A 408 to allow a decryption-encryption key A 410 to be read by the computer system 102 of FIG. 1. A decryption-encryption key B 414 remains hidden.

Another user may enter PIN B into the user input module 404 to unlock the self-authenticating token system 402. The PIN B in the block storage module 406 is associated with an authentication parameter unit B 412 to allow the decryption-encryption key B 414 to be read by the computer system 102. The decryption-encryption key A 410 remains hidden.

In this manner, a single self-authenticating token may support multiple decryption-encryption keys for multiple users for a single set of encrypted data or for multiple sets of encrypted data, as shown below.

| | Shared Partition | Separate Partitions |
|---|---|---|
| User A | Partition A | Partition A |
| User B | Partition A | Partition B |

When configured as a shared partition, user A can enter PIN A to access partition A. Likewise, user B can enter PIN B to access partition A. User B might be, in this case, a crypto-officer who wants to regain drive access if user A is no longer able to access the drive.

When configured as separate partitions, user A enters PIN A to access partition A and user B enters PIN B to access partition B. Access to each partition is mutually exclusive.

Referring now to FIG. 5, therein is shown a flow chart of a method 500 for operating the multi-factor authentication system 100 of FIG. 1. The method 500 includes: authenticating a user by a self-authenticating token system in a block 502; and retrieving a decryption-encryption key from the self-authenticating token system by a computer system after authenticating the user, the computer system using encryption to encrypt data, in a block 504.

Another embodiment includes a block storage module containing a single decryption-encryption key associated with multiple authentication parameter units. Thus, multiple users with different PINS may access the same decryption-encryption key to access the same encrypted data. When one of the multiple users should no longer have access, the PIN can be disabled without affecting access for the other users.

Yet another variation includes a block storage module containing multiple decryption-encryption keys associated with a single set of authentication parameter units. In this case, a single user may have access to multiple decryption-encryption keys for access to different sets of encrypted data.

A self-authenticating token includes: a user input module for verifying user identity; a block storage module containing decryption-encryption keys; and a communication channel for sending the decryption-encryption keys to the computer system.

The self-authenticating token further includes a user input module capable of accepting keyed input.

The self-authenticating token further includes a user input module capable of accepting biometric input.

The self-authenticating token further includes a user input module capable of accepting RF transmission input.

The self-authenticating token further includes a block storage module that prevents the decryption-encryption key(s) from being read by the computer system until the user has been validated by analyzing parameters sent from a user input module.

The self-authenticating token further includes a block storage module that prevents the decryption-encryption key(s) from being read by the computer system after a predetermined period of time.

The self-authenticating token further includes a block storage module that restricts the computer system to a single read operation of the decryption-encryption key(s) after the user has be validated.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A method for operating a multi-factor authentication system comprising:
authenticating a user by a self-authenticating token system; and
retrieving a decryption key from the self-authenticating token system by a computer system after authenticating the user, the computer system using encryption to encrypt data.

2. The method as claimed in claim 1 further comprising authenticating a further user for a single set of encrypted data or for multiple sets of encrypted data.

3. The method as claimed in claim 1 wherein authenticating the user includes authenticating the user for a single set of encrypted data or for multiple sets of encrypted data.

4. The method as claimed in claim 1 further comprising preventing the decryption key from being read by the computer system after a predetermined period of time without authenticating the user again.

5. The method as claimed in claim 1 further comprising preventing the decryption key from being provided to the computer system a second time without authenticating the user again.

6. A method for operating a multi-factor authentication system comprising:
authenticating a user by a self-authenticating token system;
retrieving a decryption-encryption key from the self-authenticating token system to a computer system after authenticating the user;
reading the decryption-encryption key by a decryption-encryption algorithm unit in the computer system; and
using the decryption-encryption algorithm unit to decipher-encrypt data for the computer system.

7. The method as claimed in claim 6 further comprising accessing a single decryption-encryption key by multiple users for a single set of encrypted data or for multiple sets of encrypted data.

8. The method as claimed in claim 6 further comprising accessing multiple decryption-encryption keys by a single user for a single set of encrypted data or for multiple sets of encrypted data.

9. The method as claimed in claim 6 further comprising:
accessing the decryption-encryption key by a user input module using a code, a biometric input, a radio frequency input, or a combination thereof; and
preventing the decryption-encryption key from being provided to the computer system after a predetermined period of time without authenticating the user again with the user input module.

10. The method as claimed in claim 6 further comprising:
accessing the decryption-encryption key by a user input module using a code, a biometric input, a radio frequency input, or a combination thereof; and
preventing the decryption-encryption key from provided to the computer system a second time without authenticating the user again with the user input module.

11. A multi-factor authentication system comprising:
a self-authenticating token system having:
an input module for authenticating a user; and
a storage module connected to the input mechanism for containing a decryption key for retrieval by a computer system after the user is authenticated.

12. The system as claimed in claim 11 further comprising an authentication parameter unit for authenticating a further user for a single set of encrypted data or for multiple sets of encrypted data.

13. The system as claimed in claim 11 further comprising authentication parameter units for authenticating the user for a single set of encrypted data or for multiple sets of encrypted data.

14. The system as claimed in claim 11 further comprising a timer for preventing the decryption key from being read by the computer system after a predetermined period of time without authenticating the user again.

15. The system as claimed in claim 11 further comprising the storage module for preventing the decryption-encryption key from being provided to the computer system a second time without authenticating the user again.

16. The system as claimed in claim 11 further comprising:
an authentication parameter unit for authenticating the user and retrieving a decryption-encryption key; and
a decryption-encryption algorithm unit in the computer system for reading the decryption-encryption key and to decipher-encrypt data for the computer system.

17. The system as claimed in claim 16 further comprising a further authentication parameter unit for accessing a single decryption-encryption key by multiple users for a single set of encrypted data or for multiple sets of encrypted data.

18. The system as claimed in claim 16 further comprising a further authentication parameter unit for accessing multiple decryption-encryption keys by a single user for a single set of encrypted data or for multiple sets of encrypted data.

19. The system as claimed in claim 16 further comprising:
a user input module for accessing the decryption-encryption key by a user input module using a code, a biometric input, a radio frequency input, or a combination thereof; and
a timer for preventing the decryption-encryption key from being provided to the computer system after a predetermined period of time without authenticating the user again with the user input module.

20. The system as claimed in claim 16 further comprising:
a user input module for accessing the decryption-encryption key by a user input module using a code, a biometric input, a radio frequency input, or a combination thereof; and
the storage module for preventing the decryption-encryption key from being provided to the computer system a second time without authenticating the user again with the user input module.
